(19) United States
(12) Patent Application Publication
(10) Pub. No.: US 2011/0153984 A1
(43) Pub. Date: Jun. 23, 2011

(54) DYNAMIC VOLTAGE CHANGE FOR MULTI-CORE PROCESSING

(76) Inventors: Andrew WOLFE, Los Gatos, CA (US); Tom CONTE, Atlanta, GA (US)

(21) Appl. No.: 12/642,870

(22) Filed: Dec. 21, 2009

(51) Int. Cl. G06F 15/76; G06F 9/30; G06F 1/26; G06F 1/04

(52) U.S. Cl. 712/42; 713/300; 713/600; 712/E09.016

(57) ABSTRACT

Embodiments of the disclosure generally set forth techniques for supplying different voltage levels and clock signals to a processor core. One example method includes determining a first workload of a first processor core in the multi-core processor for performing a first computing task associated with a first image area and a first geometric mapping between the first computing task and the first processor core, selecting a first voltage level or a first clock signal having a first clock frequency for the first processor core based on the determined first workload, wherein the first voltage level is compatible with the selected first clock frequency, initiating a voltage change to the first processor core based on the selected first voltage level, and initiating a clock change to the first processor core based on the selected first clock signal having the first clock frequency.

### BACKGROUND

Unless otherwise indicated herein, the approaches described in this section are not prior art to the claims in this application and are not admitted to be prior art by inclusion in this section.

When a processor core of a multiple core processor is given a computing task, certain voltage level is supplied to the processor core to process the computing task. Sometimes, the processor core may be supplied a particular voltage level, which results in an excess consumption of power. Other times, the processor core may be supplied another voltage level, which results in an increased amount of time used to complete the computing task.

### BRIEF DESCRIPTION OF THE DRAWINGS

The foregoing and other features of the present disclosure will become more fully apparent from the following description and appended claims, taken in conjunction with the accompanying drawings. These drawings depict only several embodiments in accordance with the disclosure and are, therefore, not to be considered limiting of its scope. The disclosure will be described with additional specificity and detail through use of the accompanying drawings.

In the drawings:

FIG. 1A is an illustration of a processor core in a multi-core processor adapted to operate based on a selected voltage level and a clock frequency;

FIG. 1B is a simplified block diagram illustrating example mapping data stored in a memory system accessible by a processor core or a host processor; FIG. 2A is a flowchart of an example method for selecting a voltage level or a clock frequency for a processor core in a multi-core processor;

FIG. 2B is a flowchart of an example selection mechanism;

FIG. 3 is a block diagram illustrating another multi-core processor having processor cores;

FIG. 4 is a block diagram illustrating a computer program product for supplying a voltage level and a clock signal to a processor core in a multi-core processor;

FIG. 5 is a flowchart further illustrating an example method for selecting a voltage level or a clock frequency for a processor core in a multi-core processor based on an image attribute; and

FIG. 6 is a block diagram of an example computing device that includes a multi-core processor and a host processor; all arranged in accordance with at least some embodiments of the present disclosure.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the Figures, can be arranged, substituted, combined, and designed in a wide variety of different configurations, all of which are explicitly contemplated and make part of this disclosure.

This disclosure is drawn, inter alia, to devices, methods, and computer programs related to supplying a voltage level or a clock signal to a processor core based on certain conditions as will be described herein.

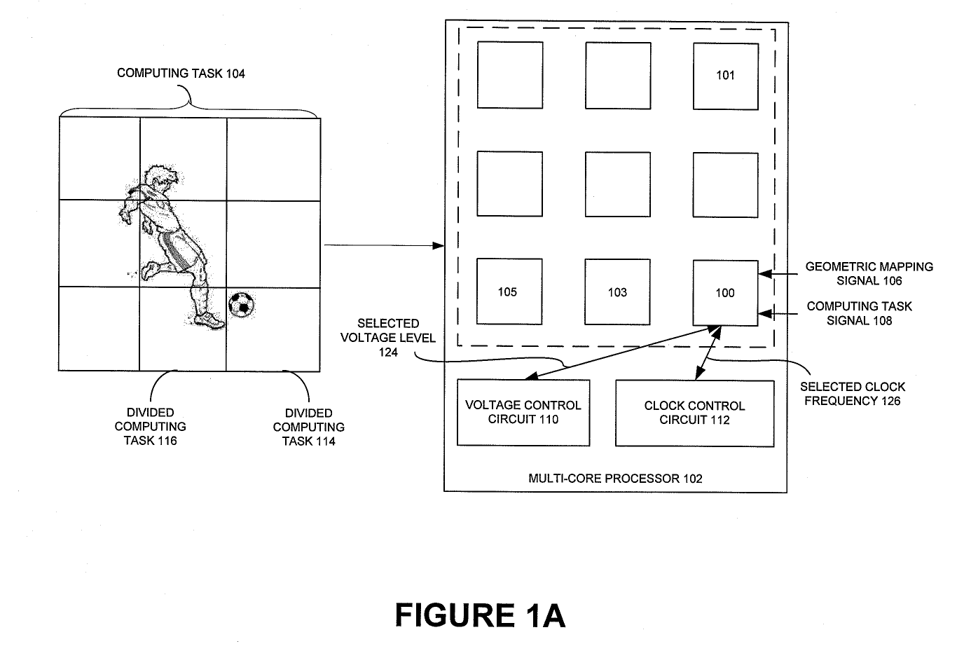

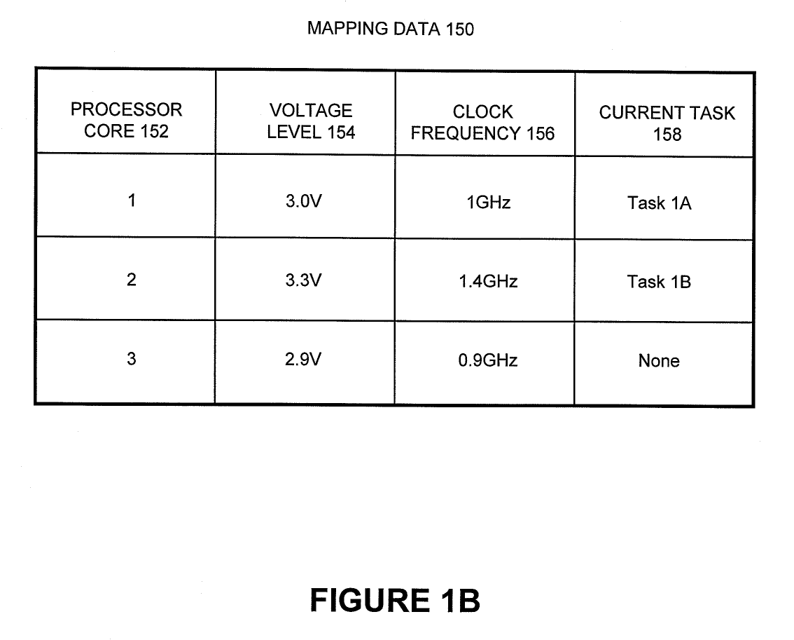

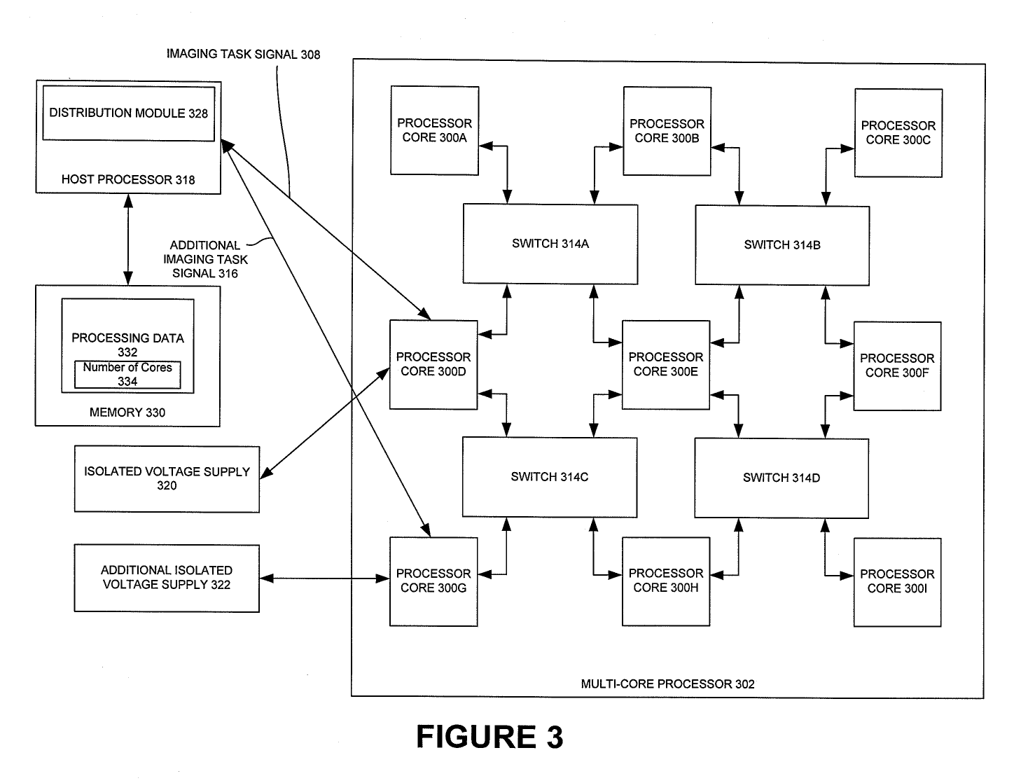

FIG. 1A is an illustration of a processor core 100 in a multi-core processor 102 adapted to operate based on a selected voltage level and a clock frequency, arranged in accordance to at least some embodiments of the present disclosure. The multi-core processor 100 may include multiple processor cores arranged in rows and columns in a 2-dimensional array. The processor cores may be interconnected by a communication network using switches, which is illustrated in FIG. 3. A processor core may be supplied a certain voltage level (e.g., a selected voltage level 124) from a voltage control circuit (e.g., a voltage control circuit 110) and a clock signal at a certain clock frequency (e.g., a selected clock frequency 126) from a clock control circuit (e.g., a clock control circuit 112).

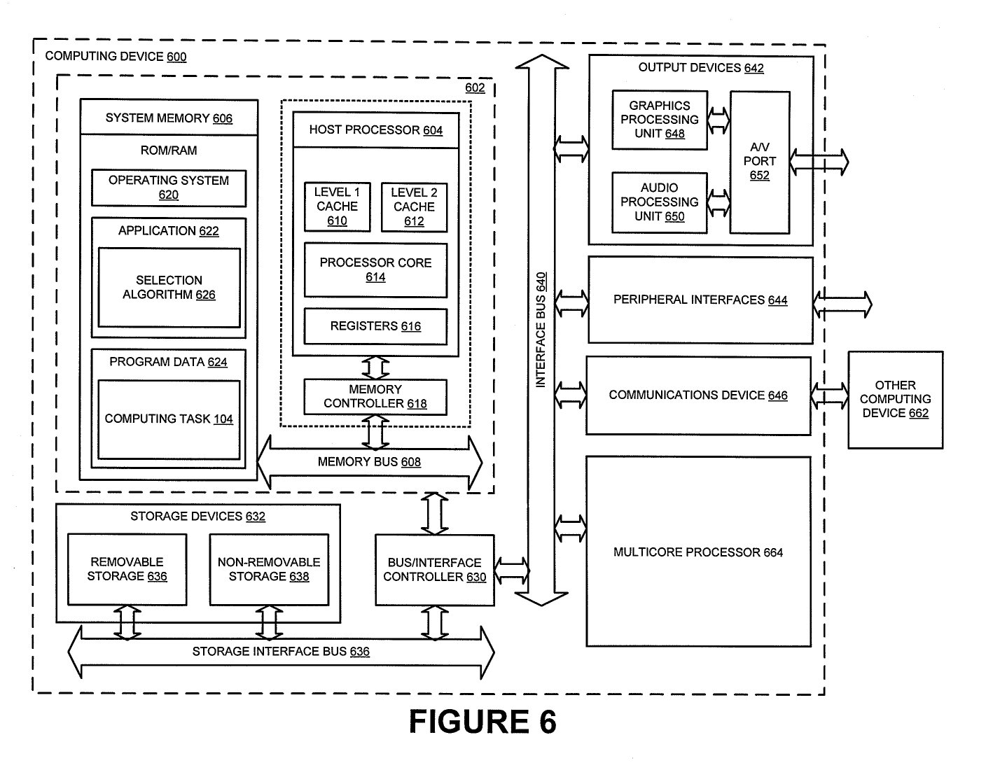

In some implementations, when the multi-core processor 102 receives a computing task 104, one of the processor cores (e.g., a processor core 101) may be configured to divide up the computing task 104 and distribute the divided computing tasks among the various processor cores of the multi-core processor 102. Alternatively, a host processor (e.g., a host processor 318 of FIG. 3 or a host processor 604 of FIG. 6) distinct from the multi-core processor 102 may divide up the computing task 104 and distribute the divided computing tasks among the processor cores of the multi-core processor 102. An example distribution module (e.g., a distribution module 328 of the host processor 318 shown in FIG. 3) may distribute the divided computing tasks based on a quantity of the processor cores of the multi-core processor 102. For a computing task associated with processing an image, such as the illustrated computing task 104, each divided computing task in some implementations may cover an equal area of the image. In other words, a divided computing task 114 may cover the same sized area as a divided computing task 116.

When the computing task 104 is divided, a geometric mapping signal 106 and a computing task signal 108 may be generated by a host processor, or one or more designated processor cores. The computing task signal 108 may convey information associated with one or more of the divided computing tasks, and the geometric mapping signal 106 may convey information associated with the geometric mapping between the divided computing task and a processor core. The information associated with the computing tasks may include pixel data, reference frame data, motion estimation data, motion compensation data, or other data that forms the basis of the computing task. The information associated with the geometric mapping may include the assignment of a particular divided computing task to one or more processor cores of the multi-core processor.

FIG. 1B is a simplified block diagram illustrating example mapping data 150 stored in a memory system accessible by a processor core or a host processor, in accordance with at least some embodiments of the present disclosure. The mapping data 150 may include a list of processor cores 152 in a multi-core processor along with each of their respective voltage levels 154, clock frequencies 156, and current tasks 158. For example, in conjunction with FIG. 1A, the current tasks 158 may include task 1A and task 1B (e.g., the divided computing task 114 and the divided computing task 116) that have been distributed to processor cores 1 and 2 (e.g., the processor cores 100 and 103), respectively. The mapping data 150 may further identify one or more processor cores that are without a task assignment, such as a processor core 3, which may correspond to the processor core 105 of FIG. 1A.

Suppose the computing task 104 is to process a two-dimensional image of a soccer player as shown in FIG. 1A. The processing for the lower right hand corner of the image (e.g., the divided computing task 114) may be geometrically mapped to a correspondingly positioned processor core 100 of the multi-core processor 102. Similarly, a portion of a three dimensional imaging computing task may be geometrically mapped to a corresponding portion of a three dimensional processor core array of a multi-core processor. A three dimensional multi-core processor may be composed of one or more layers of two dimensional multi-core processors, such that the location of a processor core within the three dimensional multi-core processor is identifiable by its length, width, and height distance from a point within the multi-core processor. A three dimensional imaging computing task may also be geometrically mapped to a two dimensional array of processor cores. Some example three dimensional imaging computing task may be a CT scan of a human being, an X-ray of an object or structure, a finite element analysis of a mechanical part, or a simulation of compressible or incompressible fluid flow.

With the geometric mapping signal 106 and the computing task signal 108, the workload of the processor core 100 may be determined based on an image attribute associated with the image area to be processed by a geometrically mapped processor core 100. An example image attribute for the image area covered by the divided computing task 114 may include a motion vector for a macroblock corresponding to such an image area. With the motion vector, the transformation from one image to another in a video sequence may be described. In other words, the amount of movement for this particular image area may be estimated, and thus the amount of workload for the divided computing task 114 to handle the movement may also be determined.

Based on the workload, one or more voltage levels and clock signals with a certain clock frequency for the processor core 100 may be selected and supplied to the processor core 100. In some implementations, a set of voltage levels and compatible clock signals having certain clock frequencies that may be used to operate a processor core may be predetermined. With this predetermined set of voltage levels and clock frequencies, a specific voltage level (e.g., the lowest voltage level) and a specific clock frequency may be selected from the set for the processor core 100. In some implementations, the workload determination and the selection may be performed by a processor core in the multi-core processor 102 other than the processor core 100 (e.g., the processor core 101). In other implementations, the workload determination and the selection may be performed by a host processor (e.g., the host processor 318 of FIG. 3) distinct from the multi-core processor 102. In yet some other implementations, the workload determination may be performed by the processor core 100. The processor core 101 or the host processor may then take the results of the determination to select the appropriate voltage level and clock frequency.

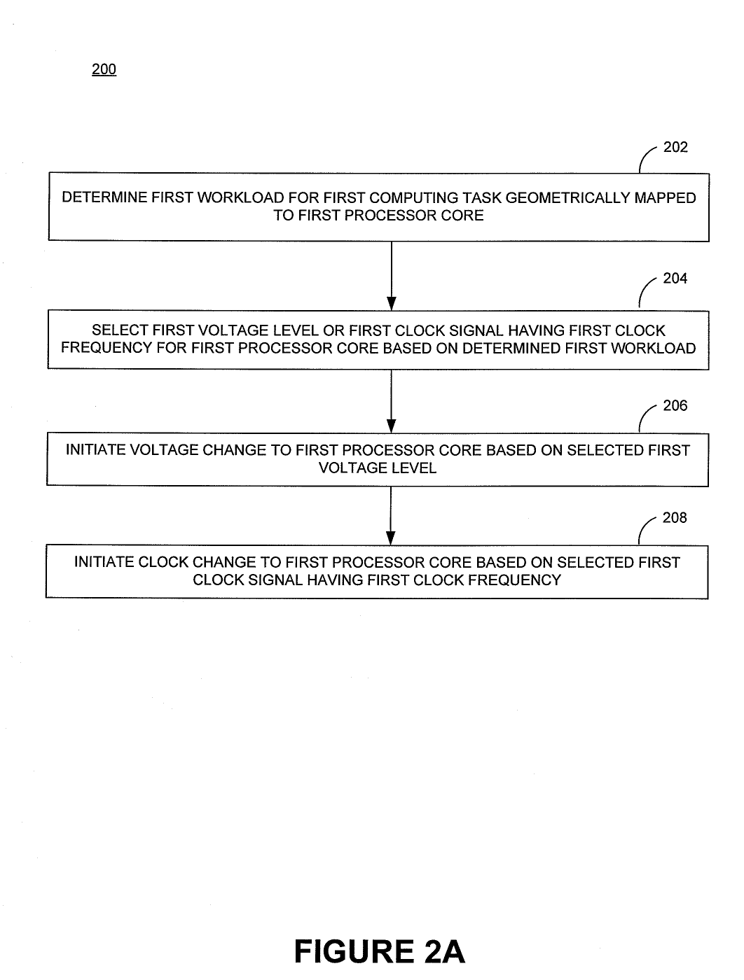

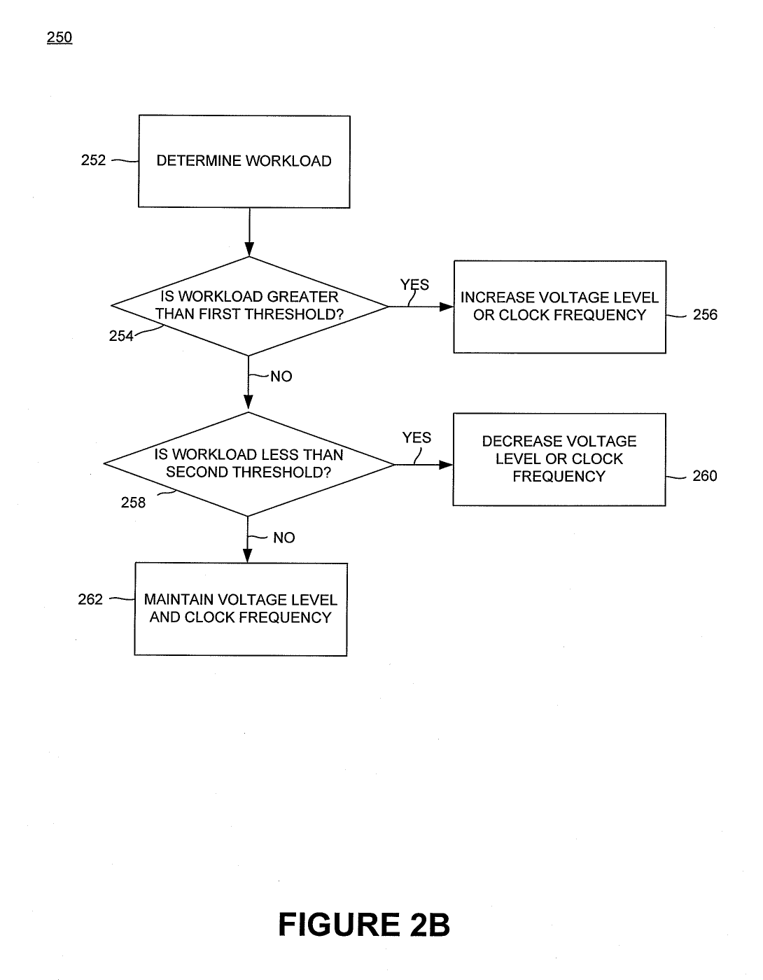

FIG. 2A is a flowchart of a method 200 for selecting a voltage level and a clock frequency for a processor core in a multi-core processor, arranged in accordance to at least some embodiments of the present disclosure. Method 200 may include one or more operations, functions or actions as illustrated by one or more of blocks 202, 204, 206, and/or 208. Although the blocks are illustrated in a sequential order, these blocks may also be performed in parallel, and/or in a different order than those described herein. Also, the various blocks may be combined into fewer blocks, divided into additional blocks, and/or eliminated based upon the desired implementation.

Processing for the method 200 may begin at block 202, “Determine First Workload for First Computing Task Geometrically Mapped to First Processor Core,” where the method 200 may be arranged to determine the first workload of the first processor core in the multi-core processor. The first workload is for the first processor core to perform a first computing task associated with a first image area and a first geometric mapping between the first computing task and the first processor core.

Processing may continue from block 202 to block 204, “Select First Voltage Level or First Clock Signal Having First Clock Frequency for the First Processor Core Based on Determined First Workload,” in which based on the first workload, a voltage level and a clock signal having a certain clock frequency may be selected from a predetermined set of voltage levels and clock frequencies that are compatible. Processing may continue from block 204 to block 206, “Initiate Voltage change to First Processor Core Based on Selected First Voltage Level,” and block 208, “Initiate Clock Change to First Processor Core Based on Selected First Clock Signal Having First Clock Frequency,” in which the selected first voltage level and the selected first clock frequency are provided to a voltage control circuit and a clock control circuit, respectively, so that the control circuits may supply the appropriate voltage level and clock signal to the first processor core.

In block 202, with the geometric mapping of the computing task, which may be adapted to process a specific image area, to the processor core, the workload for the processor core may be limited to the image area and may be determined based on the image attribute associated with the image area. As illustrated in FIG. 1A and discussed above, the geometric mapping signal 106 may convey the division of the two-dimensional image to be processed by the computing task 104 and also the assignment of the divided computing task 114 to the processor core 100 of the multi-core processor 102. The computing task signal 108 may convey the tasks to be performed by the geometrically mapped processor core 100. Here, the divided computing task 114 is illustrated to process the image area including a soccer ball. Based on the image attribute associated with this specific image area (e.g., the motion vector), the workload for the processor core 100 to perform the divided computing task 114 may be determined. For example, if there is much motion associated with the illustrated soccer ball, then the workload for the processor core 100 to perform the divided computing task 114 increases. Conversely, if there is little motion associated with the soccer ball, then the workload for the processor core 100 decreases. In some implementations, the workload may be determined within a time interval, so that the image attribute associated with the image area may be evaluated over multiple video frames. The workload may be rated in accordance with a predetermined benchmark set using a processor core to process a particular imaging task. The workload may be measured in terms of the amount of time that a processor core uses to complete a particular imaging task.

In other implementations, using the above example image area having an object (i.e., a soccer ball) as an illustration, the image attribute associated with the image area may correspond to one or more physical attributes of the soccer ball. For example, the deformation of the soccer ball due to stresses, wind, or electromagnetic forces exerted on the soccer ball may be modelled and calculated. In such a case, the workload may be estimated based on, without limitation, a number of objects assigned to each processor core, a number of lights assigned to be modelled by each processor core, or a number of tessellated polygons assigned to each processor core.

In block 204, based on the workload, a first voltage level and/or a first clock signal having a first clock frequency may be selected. One selection mechanism will described further below. In block 206 and block 208, based on the selected first voltage level and/or the selected first clock frequency, a change to the first processor core may be initiated by providing the selected first voltage level and/or the selected first clock frequency to a voltage control circuit and a clock control circuit, respectively. These two control circuits may then be adapted to supply a different voltage level and a clock signal having a different clock frequency to the first processor core.

FIG. 2B is a flowchart of an example method 250 for selecting a voltage level or a clock frequency for a processor core in a multi-core processor, arranged in accordance with at least some embodiments of the present disclosure. The example method 250 may include one or more operations, functions, or actions as illustrated by one or more of blocks 252, 254, 256, 258, 260, and/or 262. Although the blocks are illustrated in a sequential order, these blocks may also be performed in parallel, and/or in a different order than those described herein. Also, the various blocks may be combined into fewer blocks, divided into additional blocks, and/or eliminated based upon the desired implementation.

Processing for the selection mechanism may begin at block 252, “Determine Workload,” which may correspond to the processing for block 202 of FIG. 2A. Processing may continue from block 252 to block 254, “Is Workload Greater Than First Threshold,” in which the workload is compared to a first threshold to determine whether to increase either a voltage level or a clock frequency of a processor core. If the workload is greater than the first threshold, processing may continue from block 254 to block 256, “Increase Voltage Level or Clock Frequency.”

In block 256, either a voltage level or a clock frequency of a processor core can be increased. If the workload is not greater than the first threshold, then processing may continue from block 254 to block 258, “Is Workload Less Than Second Threshold?” If the workload is less than the second threshold, then processing may continue from block 258 to block 260, “Decrease Voltage Level or Clock Frequency,” in which the voltage level or clock frequency of a processor core is reduced in accordance with a lower workload. If the workload is not less than the second threshold, processing may continue from block 258 to block 262, “Maintain Voltage Level and Clock Frequency,” in which the prior voltage level and clock frequency of the processor core assigned to the particular divided computing task is preserved.

It should be noted that the methods illustrated in FIG. 2A and FIG. 2B and discussed above may be applied to more than one processor core in the multi-core processor. Using FIG. 1A as an illustration, the divided computing task 116 may be geometrically mapped to a processor core 103. The workload for the processor core 103 for performing the divided computing task 116 may also be determined, independent from the workload determination for the processor core 100. The voltage level and the clock frequency to be supplied to the processor core 103 may then be independently selected based on the determined workload.

FIG. 3 is a block diagram illustrating another multi-core processor 302 having processor cores 300A-I, arranged in accordance to at least some embodiments of the present disclosure. The multi-core processor 302 may include switches 314A-D, and the processor cores 300A-I may be coupled to each other via the switches 314A-D. In some implementations, level shifting circuitry may also be included between the processor cores 300A-I and the switches 314A-D. The multi-core processor 302 may be adapted to communicate with a host processor 318, which may include a distribution module 328. For example, the multi-core processor 302 may be arranged to receive control signals from multiple sources, such as a first control circuit 320 and a second control circuit 322. In one example, the processor core 300D may be coupled to the first control circuit 320, such as through an interface bus. The processor core 300G may be coupled to the second control circuit 322 also through the interface bus. Each of the control circuits may include a voltage level control circuit and a clock control circuit. The host processor 318 may be adapted to communicate with a memory 330, which may include processing data 332 such as data identifying a number of cores 334.

In some implementations, the host processor 318 may be configured to divide a computing task to generate multiple divided computing tasks and geometrically map a first divided computing task to the processor core 300D and a second divided computing task to the processor core 300G. The host processor 318 may also be configured to determine a first workload for the processor core 300D to process the first divided computing task and a second workload for the processor 300G to process the second divided computing task. As discussed above, the first workload determination may be performed independently from the second workload determination. With the determined first workload and the determined second workload, the host processor 318 may be configured to select a first set of voltage level and clock frequency and a second set of voltage level and clock frequency, respectively. Based on the selections, the host processor 318 then may issue separate instructions to the first control circuit 320 and the second control circuit 322, so that the appropriate voltage levels and clock signals are supplied to the processor core 300D and the processor core 300G.

In some other implementations, a processor core in the multi-core processor 302 may be designated to perform some or all of the aforementioned functions of the host processor 318. For example, a processor core 300A may be adapted to geometrically map the first divided computing task to the processor core 300D via the switch 314A and map the second divided computing task to the processor core 300G via both the switch 314A and the switch 314C. Then, the processor core 300A may also be configured to determine the first workload and the second workload for the processor core 300D and the processor core 300G, respectively. The processor core 300A may also be configured to select the appropriate voltage levels and clock signals for the two processor cores.

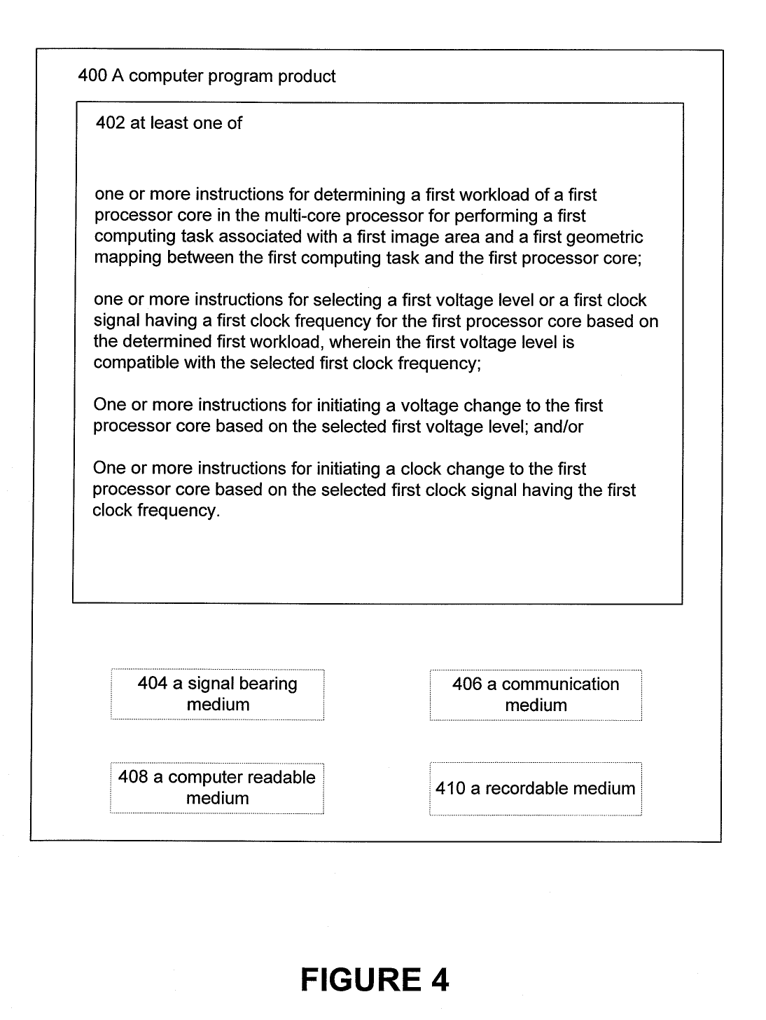

FIG. 4 is a block diagram illustrating a computer program product 400 for supplying a voltage level and a clock signal to a processor core in a multi-core processor in accordance with at least some embodiments of the present disclosure. Computer program product 400 may include one or more sets of executable instructions 402 for executing the methods for supplying a voltage level and a clock signal to a processor core based on certain conditions described herein. For illustration only, the instructions 402 may reflect the methods described above and illustrated in FIGS. 1-3. Computer program product 400 may be transmitted in a signal bearing medium 404 or another similar communication medium 406. Computer program product 400 may be recorded in a computer readable medium 408 or another similar recordable medium 410.

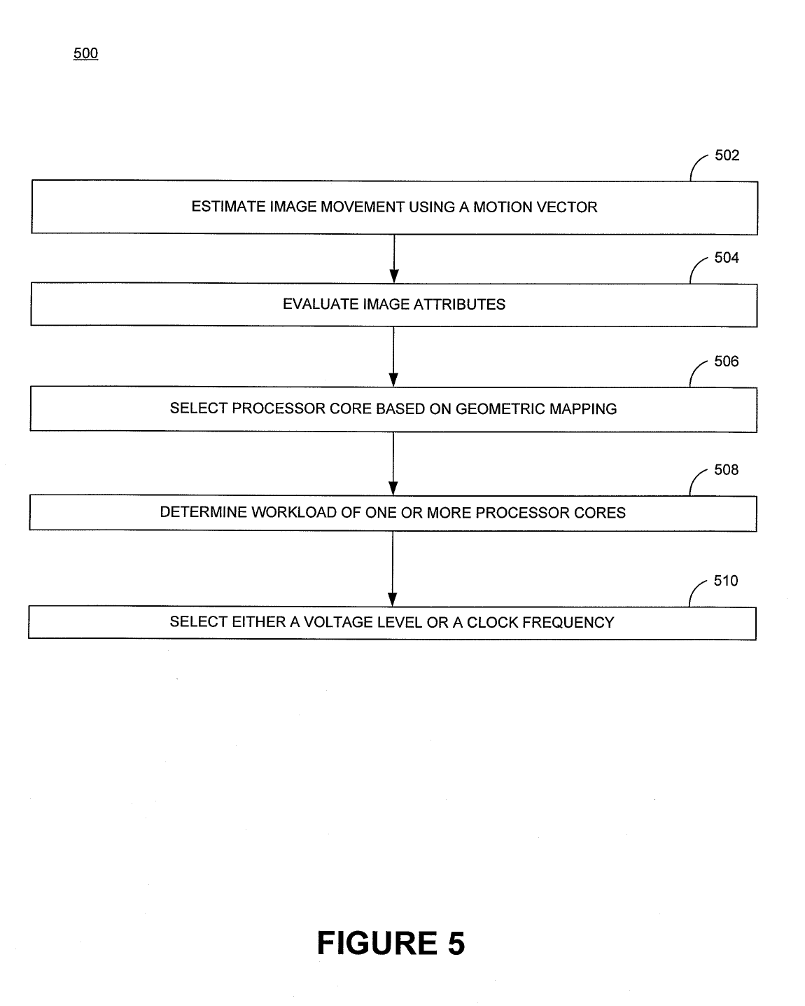

FIG. 5 is a flowchart further illustrating a method 500 for selecting a voltage level or a clock frequency for a processor core in a multi-core processor based on an image attribute, in accordance with at least some embodiments of the present disclosure. The method 500 may include one or more operations, functions or actions as illustrated by one or more of blocks 502, 504, 506, 508, and/or 510. Although the blocks are illustrated in a sequential order, these blocks may also be performed in parallel, and/or in a different order than those described herein. Also, the various blocks may be combined into fewer blocks, divided into additional blocks, and/or eliminated based upon the desired implementation.

Processing for the method 500 may begin at block 502, “Estimate Image Movement Using Motion Vector,” in which the amount of movement associated with a particular divided computing task (e.g., the divided computing task 114 or 116 of FIG. 1A) may be estimated using a motion vector. Processing may continue from block 502 to block 504, “Evaluate Image Attributes,” in which image attributes (e.g., a largest motion vector, a sum of motion vectors, or others) of the divided computing task can be evaluated to determine a workload associated with the divided computing task.

In some implementations, the processing in block 502 and block 504 may involve a motion estimation procedure, which may be configured to calculate a motion vector for a macroblock within a particular section of a video image. Furthermore, an example image attribute associated with such a section of a video image may be determined from the greatest absolute value of a motion vector for the particular section of the video image.

Processing may continue from block 504 to block 506, “Select Processor Core Based on Geometric Mapping,” in which a particular processor core (e.g., the processing core 100 or 103 of FIG. 1) can be chosen to perform a particular divided computing task based on the relative position of the divided computing task and also the relative position of the processor core in the multi-core processor. Processing may continue from block 506 to block 508, “Determine Workload of One or More Processor Cores,” in which the workload of the chosen one or more processor cores can be determined using the aforementioned image attribute associated with the divided computing task. Processing may continue from block 508 to block 510, “Select Either a Voltage Level or a Clock Frequency,” in which a voltage level or a clock frequency of the chosen processor core can be selected based on the workload of the processor core.

FIG. 6 is a block diagram of an example computing device that includes a multi-core processor and a host processor, arranged in accordance with at least some embodiments of the present disclosure. In a very basic configuration, computing device 600 typically includes one or more host processors 604 and a system memory 606. A memory bus 608 may be used for communicating between host processor 604 and system memory 606.

Depending on the desired configuration, host processor 604 may be of any type including but not limited to a microprocessor (μP), a microcontroller (μC), a digital signal processor (DSP), or any combination thereof. Processor 604 may include one more levels of caching, such as a level one cache 610 and a level two cache 612, a processor core 614, and registers 616. An example processor core 614 may include an arithmetic logic unit (ALU), a floating point unit (FPU), a digital signal processing core (DSP Core), or any combination thereof. An example memory controller 618 may also be used with processor 604, or in some implementations memory controller 618 may be an internal part of processor 604.

Depending on the desired configuration, system memory 606 may be of any type including but not limited to volatile memory (such as RAM), non-volatile memory (such as ROM, flash memory, etc.) or any combination thereof. System memory 606 may include an operating system 620, one or more applications 622, and program data 624. Application 622 may include a selection algorithm 626 that can be arranged to perform the functions as described herein including those described with respect to at least method 200 of FIG. 2A, method 250 of FIG. 2B, and method 500 of FIG. 5. Program data 624 may include a computing task data (e.g., the computing task 104 of FIG. 1) that may be useful for selecting a voltage level and/or a clock frequency of a processor core as is described herein. In some embodiments, application 622 may be arranged to operate with program data 624 on operating system 620 such that implementations of voltage level selection and/or clock frequency selection of a processor core in a multi-core processor may be performed as described herein. This described basic configuration 602 is illustrated in FIG. 6 by those components within the inner dashed line.

Computing device 600 may have additional features or functionality, and additional interfaces to facilitate communications between basic configuration 602 and any required devices and interfaces. For example, a bus/interface controller 630 may be used to facilitate communications between basic configuration 602 and one or more data storage devices 632 via a storage interface bus 634. Data storage devices 632 may be removable storage devices 636, non-removable storage devices 638, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

System memory 606, removable storage devices 636 and non-removable storage devices 638 are examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by computing device 600. Any such computer storage media may be part of computing device 600.

Computing device 600 may also include an interface bus 640 for facilitating communication from various interface devices (e.g., output devices 642, peripheral interfaces 644, and communication devices 646) to basic configuration 602 via bus/interface controller 630. Example output devices 642 include a graphics processing unit 648 and an audio processing unit 650, which may be configured to communicate to various external devices such as a display or speakers via one or more A/V ports 652. Example peripheral interfaces 644 include a serial interface controller or a parallel interface controller, which may be configured to communicate with external devices such as input devices (e.g., keyboard, mouse, pen, voice input device, touch input device, etc.) or other peripheral devices (e.g., printer, scanner, etc.) via one or more I/O ports 658. An example communication device 646 includes a network controller, which may be arranged to facilitate communications with one or more other computing devices 662 over a network communication link via one or more communication ports. In some implementations, computing device 600 includes a multi-core processor 664, which may communicate with the host processor 604 through the interface bus 640.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

Computing device 600 may be implemented as a portion of a small-form factor portable (or mobile) electronic device such as a cell phone, a personal data assistant (PDA), a personal media player device, a wireless web-watch device, a personal headset device, an application specific device, or a hybrid device that include any of the above functions. Computing device 600 may also be implemented as a personal computer including both laptop computer and non-laptop computer configurations.

There is little distinction left between hardware and software implementations of aspects of systems; the use of hardware or software is generally (but not always, in that in certain contexts the choice between hardware and software can become significant) a design choice representing cost vs. efficiency tradeoffs. There are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link and/or channel, a wireless communication link and/or channel, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components contained within, or connected with, different other components. It is to be understood that such depicted architectures are merely examples and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

We claim:

1. A method for supplying a voltage level and a clock signal having a clock frequency to a processor core of a multi-core processor to process an image area based on a an image attribute, the method comprising:
determining a first workload of a first processor core in the multi-core processor for performing a first computing task associated with a first image area and a first geometric mapping between the first computing task and the first processor core;
selecting a first voltage level or a first clock signal having a first clock frequency for the first processor core based on the determined first workload, wherein the first voltage level is compatible with the selected first clock frequency;
initiating a voltage change to the first processor core based on the selected first voltage level; and
initiating a clock change to the first processor core based on the selected first clock signal having the first clock frequency.

2. The method of claim 1, wherein the first computing task is a part of a computing task associated with processing an image including the first image area and a second image area.

3. The method of claim 1, wherein the first workload is determined within a time interval.

4. The method of claim 1, wherein the first voltage level and the first clock frequency are selected from a predetermined set of voltage levels and clock frequencies that are compatible with one another.

5. The method of claim 1, wherein the first geometric mapping between the first computing task and the first processor core is based on a physical location of the first image area within the image.

6. The method of claim 2, further comprising dividing the computing task based on a number of processor cores available in the multi-core processor.

7. The method of claim 2, further comprising:
determining a second workload of a second processor core in the multi-core processor for performing a second computing task associated with processing the second image area based on a second image attribute and a second geometric mapping between the second computing task and the second processor core;
selecting a second voltage level or a second clock signal having a second clock frequency for the second processor core based on the second workload, wherein the second voltage level is compatible with the second clock frequency; and
initiating a second voltage change or a second clock signal change to the selected second voltage level or the selected in the second processor core.

8. The method of claim 7, wherein the first voltage level and the first clock signal for the first processor core are independently controllable with respect to the second voltage level and the second signal for the second processor core.

9. The method of claim 1, wherein the first workload is determined using a first image attribute that includes a motion vector for the first image area by a host processor or a designated processor core.

10. A multi-core processor configured to dynamically modify a voltage level and a clock signal for a processor core, comprising:
a first control circuit configured to supply a first voltage level and a first clock signal having a first clock frequency, wherein the first voltage level and the first clock signal are selectable;
a first processor core adapted to execute assigned tasks, wherein the first processor core is operated at the first voltage level with the first clock frequency from the first control circuit; and
a designated processor core configured to
determine a first workload of the first processor core to execute a first computing task of processing a first image area based on a first image attribute associated with the first image area and a first geometric mapping between the first computing task and the first processor core, select the first voltage level or the first clock signal having the first clock based on the first workload, wherein the first voltage level is compatible with the first clock frequency,
issue instructions to the first control circuit to supply the first voltage level to the first processor core, and
issue instructions to the first control circuit to supply the first clock signal having the first clock frequency to the first processor core.

11. The multi-core processor of claim 10, wherein the first computing task is a part of a computing task associated with processing an image including the first image area and a second image area.

12. The multi-core processor of claim 10, wherein the designated processor core is configured to select the first voltage level and the first clock frequency from a predetermined set of voltage levels and clock frequencies that are compatible.

13. The multi-core processor of claim 10, wherein the first geometric mapping between the first computing task and the first processor core is based on a physical location of the first image area within the image.

14. The multi-core processor of claim 11, further comprising:
a second control circuit configured to supply a second voltage level and a second clock signal having a second clock frequency, wherein the second voltage level and the second clock signal are selectable;
a second processor core adapted to execute assigned tasks, wherein the second processor core is operated at the second voltage level with the second clock frequency from the second control circuit; and
the designated processor core is configured to
determine a second workload of the second processor core for performing a second computing task of processing the second image area based on a second image attribute and a second geometric mapping between the second computing task and the second processor core,
select the second voltage level and the second clock signal having the second clock frequency for the second processor core based on the second workload, wherein the second voltage level is compatible with the second clock frequency,
issue instructions to the second control circuit to supply the second voltage level to the second processor core, and
issue instructions to second control circuit to supply the second clock signal having the second clock frequency to the second processor core.

15. The multi-core processor of claim 10, wherein the first computing task is associated with processing a first image attribute that includes a motion vector for the first image area.

16. A computer-readable medium containing a sequence of instructions for selecting a voltage level and a clock signal having a clock frequency to supply to a processor core in a multi-core processor, which when executed by a processor, causes the processor to:
determine a first workload of a first processor core in the multi-core processor for performing a first computing task associated with a first image area and a first geometric mapping between the first computing task and the first processor core;
select a first voltage level or a first clock signal having a first clock frequency for the first processor core based on the determined first workload, wherein the first voltage level is compatible with the selected first clock frequency;
initiate a voltage change to the first processor core based on the selected first voltage level; and
initiate a clock change to the first processor core based on the selected first clock signal having the first clock frequency.

17. The computer-readable medium of claim 16, wherein the first computing task is a part of a computing task associated with processing an image including the first image area and a second image area.

18. The computer-readable medium of claim 16, wherein the first geometric mapping between the first computing task and the first processor core is based on a physical location of the first image area within the image.

19. The computer-readable medium of claim 17, further containing a sequence of instructions, which when executed by the processor, causes the processor to:
determine a second workload of a second processor core in the multi-core processor for performing a second computing task associated with processing the second image area based on a second image attribute and a second geometric mapping between the second computing task and the second processor core;
select a second voltage level and a second clock signal having a second clock frequency for the second processor core based on the second workload, wherein the second voltage level is compatible with the second clock frequency; and
cause the second voltage level and the second clock signal having the second clock frequency to be supplied to the second processor core.

20. The computer-readable medium of claim 16, wherein the first image attribute includes a motion vector for the first image area.
